(19) United States
(12) Patent Application Publication
(10) Pub. No.: US 2008/0149832 A1
(43) Pub. Date: Jun. 26, 2008

(54) Scanning Probe Microscope, Nanomanipulator with Nanospool, Motor, nucleotide cassette and Gaming application

(76) Inventor: Miguel Zorn, (US)

Correspondence Address: Miguel Zorn, Apt#31, 4820 SW Barbur Blvd, Portland, OR, 97239, US

(21) Appl. No.: 11/613,738

(22) Filed: Dec. 20, 2006

(51) Int. Cl. G01N 23/00; H02K 41/00

(52) U.S. Cl. 250/311; 250/306; 310/12; 977/869

(57) ABSTRACT

This invention has applications as a scanning probe microscope/nanomanipulator with consumer gaming applications. An integrated compound lever cantilever which can function simultaneously as both a sample substrate actuator and probe tip scanner actuator for modulation of one or more probe tip. In one embodiment a piezoelectric multimorph MEMS structure is fabricated which serves as a Scanning Probe Microscope cantilever probe tip scanner and allows for the substrate to be moved in more than 1 Degree of freedom with subnanometer resolution. Nanomanipulation means such as nanotweezer, nanopore and nanomachine embodiments are possible uses for the device in addition to data storage. Parallel array operation of many sets of cantilevers is a preferred embodiment which can be used as a nanoscale manipulation and fabrication means. In addition an embodiment where the actuation effects of the device are used to propel the scanner can allow for a programmable drivable MEMS/NEMS based autonomous or semi-autonomous robotic scanner, manipulator and assembler. The device has embodiments where it is essentially a planarized MEMS/NEMS derivative version of a Besocke type scanner. The invention also discloses uses for scanning probe microscopes and nanomanipulators as means for gaming systems, erector set and chemistry kit for entertainment and educational applications. Other applications include rotational actuation, linear motion and spooling of material on rotational bodies through coordination of the actuator probe or probes.

### TECHNICAL FIELD

This invention relates to scanning probe microscopes and nanomanipulators and for high-speed, scanning probes for use in scanning probe microscopes to obtain nanometer spatial resolution characterization, imaging, characterization, nanolithography or nanomanipulation. Integration of probe tip scanners and inertial slider actuators on a single substrate are disclosed. A Besocke like actuator and scanner is fabricated in a planar form with MEMS/NEMS micromachining methods. In particular one of the embodiments discloses a MEMS/NEMS based integrated cantilevers can be formed which posses the ability to move one or more sample substrates while simultaneously functioning as imaging actuators for scanning probe microscopy and nanomanipulator tweezers devices, nanopores and motors. The device can be used for means comprising SPM microscope, nanomanipulator, nanotweezer, ultra density data recording and reading devices. In addition the present invention relates to embodiments where a scanning probe microscope or nanomanipulator is used as a gaming system by users. Various applications for nanoscale board game and electronic computer game interactions with scanning probe microscope substrate states and assemblies is described. The invention can thus be used for novel consumer electronics embodiments in devices for education and entertainment purposes. Integrated MEMS/NEMS packaged devices are especially user friendly in terms of being streamlined and simplified or automated for novice users.

### BACKGROUND ART

Scanning probe microscopes are imaging, analysis and material modification devices which can attain single atom imaging and manipulation resolution and constitute a prime means for nanoscale science and future manufacturing activities. Formation of integrated MEMS based SPM tip arrays and integrated actuator assemblies can be seen in prior art citations those for the following. The millipede project by IBM is an example of a massively parallel scanning probe thermal mechanical data recording device which has reached past prototype phase and into design for manufacturing and pilot stage. Nanochip uses MEMS scanning probe array technology for data storage applications. These devices generally have a significant drawback in that the lateral and Z axis actuators and the sample or probe movement actuators are not integrated onto macro scale inertial slider mechanisms has limited the integration and introduction of massively parallel SPM probe devices. In addition limited implementation of variable resonance cantilevers has been implemented so as to allow facile modulation of the cantilever oscillation parameters after fabrication. “Nanofactories based on a fleet of scientific instruments configured as autonomous robots” Journal of Micromechatronics by Sylvain Martel and Ian Hunter of MIT envisions use of STM robots equipped for nanoscale fabrication and measurement. Autonomous and pseudo-autonomous machines/robots with SPM capable scanner devices fabricated using parts or entire systems based upon MEMS and NEMS fabrication methods are currently an area of research. Implementation of a cantilever with combined actuator sample substrate and SPM probe tip scanner functions into an integrated structure has not been achieved as of yet. The piezo device described in the prior art J. Chu, Z. Wang, R. Maeda, K. Kataoka, T. Itoh, and T. Suga, Journal of Vacuum Science & Technology B: Microelectronics and Nanometer Structures—November 2000—Volume 18, Issue 6, pp. 3604-3607 describes a multiple axis SPM actuator but does not have gaming software, a MEMS or NEMS based inertial slider mechanism for substrate movement nor does it integrate scanner probe actuation and sample substrate actuation. In addition the device does not use the novel compound lever of the instant invention and is thus of limited importance in certain applications. Prior art use NCLT Game-based Simulation by Hyung-Seok Hahm of University Illinois Champaign Urbana describes use of simulation for nanoscale educational games but does not combine the user interface with a Scanning probe microscope. Thus, this citation does not provide means or suggestions for integration of SPM hardware with gaming software. Interesting related prior art technology can be found in Sonnenwald, D. H., R. E. Bergquist, K. L. Maglaughlin, E. Kupstas-Soo, and M. C. Whitton. “Designing to Support Collaborative Scientific Research Across Distances: The nanoManipulator Environment,” Collaborative Virtual Environments, E. Churchill, D. Environment Snowdon, and A. Munro eds. London: Springer Verlag, 2001, 202-224 as well as Taylor, R. M., II and R. Superfine. “Advanced Interfaces to Scanned-Probe Microscopes,” Handbook of Nanostructured Materials and Nanotechnology, Vol. 2, H. S. Nalwa ed. New York: Academic Press, 1999,271-308. Describe nanomanipulator systems for research processes. In addition Chapter 40 Virtual Reality and Haptics in Nano- and Bionanotechnology, Gaurav Sharma, Constantinos Mavroidis and Antoine Ferreira in the Handbook of Theoretical and Computational Nanotechnology, Edited by Michael Rieth and Wolfram Schommers Volume X: Pages (1-33). This article addresses issues of integration and user interface as well as nanomanipulator probe sample interaction. Teleoperated scanning probe nanomanipulator systems are described in S. Horiguchi et al., “Virtual Reality User Interface for Teleoperated Nanometer Scale Object Manipulation, Proceedings of the 7th International IEEE Workshop on Robot and Human Communication,” ROMAN'98, Takamatsu, Japan, 1998, pp. 142-147.© 1998, IEEE. These above articles do not address use of Scanning probe microscope nanomanipulators for gaming entertainment purposes by integration of SPM hardware with gaming software. Nanochip Inc (nanochip.com) produces scanning probe microscope probe array based memory storage chips based upon technology found in U.S. Pat. No. 5,453,970, application Ser. No. 10/684,661 and 2006/0120140A1. Nanochip inc has licensed phase change storage technology from Ovonyx, Inc at www.ovonyx.com. These described technology does not provide gaming applications for scanning probe or nanomanipulator or rotational stepper actuation modes of the instant invention. Internal publication “A simplified Besocke. scanning tunneling microscope with linear approach geometry” S. J. Ball, G. E. Contant and A. B. McLean, Department of Physics, Queen's University, Kingston, Ontario, Canada, K7L 3N6 (Dated: Sep. 30, 2004). These described technology does not provide gaming applications for scanning probe or nanomanipulator or rotational stepper actuation modes of the instant invention. Useful anisotropic etching methods for silicon wafer fabrication of cantilever components can be found in “Si multiprobes integrated with lateral actuators for independent scanning probe applications” by Yoomin Ahn et al 2005 J. Micromech. Microeng. 15 1224-1229 doi:10.1088/0960-1317/15/6/012. This cited does not provide means for gaming applications for scanning probe or nanomanipulator or rotational stepper actuation modes of the instant invention. In addition the novel compound cantilever design of the instant invention is not described by the cited invention. U.S. Pat. No. 6,707,308 Michalewicz Mar. 16, 2004 describes a tunneling sensor for high resolution motion detection. It should be noted that it is foreseen that a combination of the present invention disclosed design and methods with this prior art technology would provide a synergistic application for detection method for actuation of the sensor actuator means disclosed by the instant invention. This described technology does not provide gaming applications for scanning probe or nanomanipulator or rotational stepper actuation modes of the instant invention. United States Patent Application-20060172283 describes a novel molecular separation and analysis device and methods for use as a means for separating extremely small amounts of material. The cited patent application does not provide gaming applications for scanning probe, rotational nanostepper spooling device or nanomanipulator modes of the instant invention. United States Patent Application 2006/0057585 describes use of a translocation mechanism with a nanopore for scanning polymer structural and physical properties. This device does not provide rotational actuated stepping or spooling modes. The use of a rotating spooling mechanism in the instant invention allows for compact storage of long flexible objects in particular DNA/RNA and nanostructures. In addition the described technology of the cited patent application does not provide gaming applications for scanning probe or nanomanipulator or rotational stepper actuation modes of the instant invention. U.S. Pat. No. 6,706,203 describes nanopore structures for scanning nanoscale objects such as nucleotide and proteins via electrophoresis and electrochemical ion flow through the nanopore as the object traverses the nanopore. Certain embodiments of the present invention use a rotation spooling process to scan an object through sensor structures comprising tunneling sensors, nanopore or nanonotch structures. The cited invention does not provide nor contemplate rotational stepping means or modes for causing objects to traverse a nanostructure. U.S. Pat. No. 6,862,924 describes a haptic interface for virtual reality interaction with a scanning probe microscope. The cited invention does not integrate gaming software with the scanning probe nanomanipulator or haptic device.

Relevant Publications Include:
1. Koichiro Takeuchi and Yukio Kasahara, “High-Speed Optical Sampling Measurement Of Electrical Waveform Using a Scanning Tunneling Microscope”, APPL. PHYS. LETT. 63 (26), 27 Dec. 1993 (Received 27 Jul. 1993). Teratec Corp. 2-9-32 Naka-cho, Musashino, Tokyo 180 Japan.
2. S. Weiss, D. F. Ogletree, M. Salmeron and D. S. Chemia, “Ultrafast Scanning Probe Microscopy”, APPL. PHYS. LETT. 63, (18), 1 Nov. 1993 (Received 17 Jun. 1993). Lawrence Berkeley Laboratory, Berkeley, Calif. 94720.
3. S. Weiss, D. Botkin, D. S. Chemia, “Ultrafast Scanning Microscopy”, OSA PROCEEDINGS ON ULTRAFAST ELECTRONICS AND OPTOELECTRONICS, 1993, Vol. 14, Jagdeep Shah and Umest Mishra (eds.), p. 162. Same address as above.
4. A. S. Hou, F. Ho, D. M. Bloom, “Picosecond Electrical Sampling Using A Scanning Force Microscope”, OSA PROCEEDINGS ON ULTRAFAST ELECTRONICS AND OPTOELECTRONICS, 1993, VOl. 14, Jagdeep Shah and Umest Mishra (eds.), p. 166.
5. Y. K. Kim, J. M. Bae, S. Y. Son, J. H. Choi, and S. G. Kim, in Proc of MOEMS '99 (Mainz, Germany, September 1999).
6. C. Lee, T. Itoh, T. Ohashi, R. Maeda, and T. Suga, American Vacuum Society Technol. B, 15(4), 1559 (1997).
7. Weiguo Liu et al., Thin Solid Films, 31, 254 (2001).
8. K. Yamashita et al., in Proc. of the 11th International Conference on Solid State Sensors and Actuators (Transducers, Munich, Germany, June 2001).
9. Y. Jeon, Fabrication and Characterization of the PZT Thick Films on Silicon Substrates for MEMS Applications, Ph.D. Thesis (KAIST, Taejun, 2001).
10. C. W. Wong, W. C. Shih, Y. Jeon, S. G. Kim, and G. Barbastathis, Solid-State Sensor, Actuator and Microsystems Workshop (Hilton Head, S.C., June 2002), p. 342.
11. D. M. Freeman et. al., Solid State Sensors and Actuators Workshop (Hilton Head, S.C., June 1998), p. 150.
12. Water-Immersible Micromachined Pb(Zr,Ti)O3 Thin Film Actuators YONGBAE JEON, CHEE WEI WONG & SANG-GOOK KIM Micro and Nano Systems Laboratory, 77 Massachusetts Avenue, 5-026, Cambridge, Mass. 02139, Department of Mechanical Engineering, Massachusetts Institute of Technology, USA
13. G. Binnig and H. Rohrer, Helv. Phys. Acta. 55, 726 (1982).
14. G. Binnig, H. Rohrer, C. Gerber, and E. Weibel, Phys. Rev. Lett. 49, 57 (1982).
15. J. A. Venables, Surface and Thin Film Processes (Cambridge University Press, Cambridge, 2000).
16. A. Zangwill, Physics at Surfaces (Cambridge University Press, Cambridge, 1988).
17. D. W. Pohl, IBM J. Res. Develop. 30, 417 (1986).
18. C. J. Chen, Introduction to Scanning Tunneling Microscopy (Oxford University Press, New York, Oxford, 1993).
19. E. Meyer, H. J. Hug, and R. Bennewitz, Scanning Probe Microscopy (Springer-Verlag, Berlin Heidelberg, 2004).
20. K. Besocke, Surf. Sci. 181, 145 (1987).
21. J. Frohn, J. F. Wolf, K. Besocke, and M. Teske, Rev. Sci. Instrum. 60, 1200 (1989).
22. S. Park and R. C. Barrett, Methods of Expt. Phys. 27, 31 (1993).
23. S. Behler, M. K. Rose, J. C. Dunphy, D. F. Ogletree, and M. Salmeron, Rev. Sci. Instrum. 68, 2479 (1997).
24. S. Horch, P. Zeppenfeld, R. David, and G. Cosma, Rev. Sci. Instrum. 65, 3204 (1994).
25. S. Horch, P. Zeppenfeld, R. David, and G. Cosma, Rev. Sci. Instrum. 66, 3717 (1995).
26. G. Meyer, Rev. Sci. Instrum. 67, 2960 (1996).
27. B. C. Stipe, Ph.D. thesis, Cornell University (1998).
28. M. A. Rezaei, Ph.D. thesis, Cornell University (1998).
29. B. C. Stipe, M. A. Rezaei, and W. Ho, Rev. Sci. Instrum. 70, 137 (1999).
30. B. C. Stipe, M. A. Rezaei, and W. Ho, Science 280, 1732 (1998).
31. W. Ho, J. Chem. Phys. 117, 11033 (2002).
32. N. Nilius, T. M. Wallis, and W. Ho, Science 297, 1853 (2002).
33. N. Nilius, T. M. Wallis, and W. Ho, Phys. Rev. Lett. 90, 186102 (2003).
34. G. V. Nazin, X. H. Qiu, and W. Ho, Phys. Rev. Lett. 90, 216110 (2003).
35. M. Wilms, M. Schmidt, G. Bermes, and K. Wandelt, Rev. Sci. Instrum. 69, 2696 (1998).
36. B. Fischer, Ph.D. thesis, Ecole. Polytechnique F'ed'erale de Lausanne (1998).
37. J. Bay et al.; Micromachined AFM transducer with differential capacitive read-out; J. Micromech. Microeng. 5(1995) 161-165.
38. Y. Xu et al.; Integrated micro-scanning tunneling microscopy; Appl. Phys. Lett: 67(16) (1995) 2305-2307.
39. T. Itoh; Piezo. Cantilever Array for Multiprobe Scanning Force Microscopy; IEEE-7803-2985-June 1996, pp 451-455.
40. S. C. Minne; Paralleled atomic force microscopy using cantilever with integrated piexoresistive sensors and integrated piezoelectric actuators; Apply Phys. Lett 67(26), Dec. 25, 1995.
41. M. Tortonese et al.; Appl. Phys. Lett. 62(8) Feb. 2, 1993, pp. 834-836.
42. L. C. Kong;. Int. Electrostatically Resonant Scan tip for an atomic force microscope; J. Vac Sci. Tech. B 11(3), May/June 1993, p. 634-641.
43. Xu et al, Microelectromechanical Scanning Tunneling Microscope Transducers '95, The 8th International Conference on Solid-State Sensors and Actuators, and Eurosensors IX, June 15-29, 1995, pp. 640-643.
44. Sonnenwald, D. H., R. E. Bergquist, K. L. Maglaughlin; E. Kupstas-Soo, and M. C. Whitton. “Designing to Support Collaborative Scientific Research Across Distances: The nanoManipulator Environment,” Collaborative Virtual Environments, E. Churchill, D. Environment Snowdon, and A. Munro eds. London: Springer Verlag, 2001, 202-224
45. Taylor, R. M., II and R. Superfine. “Advanced Interfaces to Scanned-Probe Microscopes,” Handbook of Nanostructured Materials and Nanotechnology, Vol. 2, H. S. Nalwa ed. New York: Academic Press, 1999, 271-308. Describe nanomanipulator systems for research processes.
46. Chapter 40 Virtual Reality and Haptics in Nano- and Bionanotechnology, Gaurav Sharma, Constantinos Mavroidis and Antoine Ferreira in the Handbook of Theoretical and Computational Nanotechnology, Edited by Michael Rieth and Wolfram Schommers Volume X: Pages (1-33).
47. Teleoperated scanning probe nanomanipulator systems are described in S. Horiguchi et al., “Virtual Reality User Interface for Teleoperated Nanometer Scale Object Manipulation, Proceedings of the 7th International IEEE Workshop on Robot and Human Communication,” ROMAN'98, Takamatsu, Japan, 1998, pp. 142-147.© 1998, IEEE.
48. K. Besocke, Surf. Sci. 181, 145 (1987).
49. J. Frohn, J. F. Wolf, K. Besocke, and M. Teske, Rev. Sci. Instrum. 60, 1200 (1989).
50. S. Park and R. C. Barrett, Methods of Expt. Phys. 27, 31 (1993).
51. S. Behler, M. K. Rose, J. C. Dunphy, D. F. Ogletree, and M. Salmeron, Rev. Sci. Instrum. 68, 2479 (1997).
52. S. Horch, P. Zeppenfeld, R. David, and G. Cosma, Rev. Sci. Instrum. 65, 3204 (1994).
53. S. Horch, P. Zeppenfeld, R. David, and G. Cosma, Rev. Sci. Instrum. 66, 3717 (1995).
54. G. Meyer, Rev. Sci. Instrum. 67, 2960 (1996).
55. B. C. Stipe, Ph.D. thesis, Cornell University (1998).
56. M. A. Rezaei, Ph.D. thesis, Cornell University (1998).
57. B. C. Stipe, M. A. Rezaei, and W. Ho, Rev. Sci. Instrum. 70, 137 (1999).
58. B. C. Stipe, M. A. Rezaei, and W. Ho, Science 280, 1732 (1998).
59. P. Garrou, “Future ICs Go Vertical ,” Semiconductor International, February 2005, Vol 28, No. 2.
60. P. Garrou, “is Wafer Interconnect Going 3D?” 56th Electronic Component Tech. Conf. (ECTC), 2006.
61. R. Patti, “3D Design to Volume: A Look at Various 3D Applications, Their Designs, and Ultimate Silicon Results,” 3D Architectures for 3D Integration and Packaging, June 2005.
62. M. Koyanagi, “A New Super Smart Stack Technology for 3D LSIs,” 3D Architectures for 3D Integration and Packaging, June 2005.
63. A. Topol et al., “Enabling Technologies for Wafer Level Bonding of 3D MEMS and Integrated Circuit Structures,” Proc. Electronic Component Tech. Conf. ECTC), 2004, p. 931.
64. M. Umemoto, “High Performance Vertical Interconnection for High Density 3D Chip Stacking Package,” 54th Electronic Component Tech. Conf., 2006, p. 616.
65. C. Bower et al., “High Density Vertical Interconnects for 3D Integration of Silicon Integrated Circuits,” Proc. 56th Electronic Component Tech. Conf. (ECTC), 2006; p. 399.
66. Z. Lemanos and J. Zolper, “Integrated Microsystems: The Next Technology Transition,” ManTech, 2004</OL
67. Nanochip Inc (nanochip.com) produces scanning probe microscope probe array based memory storage chips based upon technology found in U.S. Pat. No. 5,453,970, application Ser. No. 10/684,661 and 2006/0120140A1. Nanochip inc has licensed phase change storage technology from Ovonyx, Inc at www.ovonyx.com
68. Internal publication “A simplified Besocke scanning tunneling microscope with linear approach geometry” S. J. Ball, G. E. Contant and A. B. McLean ,Department of Physics, Queen's University, Kingston, Ontario, Canada, K7L 3N6.(Dated: Sep. 30, 2004)
69. “Si multiprobes integrated with lateral actuators for independent scanning probe applications” by Yoomin Ahn et al 2005 J. Micromech. Microeng. 15 1224-1229 doi: 10.1088/0960-1317/15/6/012 U.S. Pat. No. 6,707,308 Michalewicz Mar. 16, 2004 describes a tunneling sensor for high resolution motion detection. It should be noted that it is forseen that a combination of the present invention disclosed design and methods with this prior art technology would provide a synergistic application for detection method for actuation of the sensor actuator means disclosed by the instant invention. United States Patent Application 2006/0057585 describes use of a translocation mechanism with a nanopore for scanning polymer structural and physical properties. Wafer and chip stacking references can be found in the following references and at ZyCube inc and Tezzaron Inc, two companies specializing in 3D chip assembly technology. Tezzaron (Singapore) with their “Super Contact” technology.

Extensive references to methods for single atom and molecule manipulation can be found in “Scanning tunneling microscopy single atom/molecule manipulation and its application to nanoscience and technology” Saw-Wai Hlaa J. Vac. Sci. Technol. B 23, 4 . . . , July/August 2005 1351-1360 p. “Writing with molecules on molecular print boards” Olga Crespo-Biel, Bart Jan Ravoo, Jurriaan Huskens and David N. Reinhoudt, Dalton Trans., 2006, 2737-2741, DOI: 10.1039/b517699a Clemens Mueller-Falcke, Yong-Ak Song and Sang-Gook Kim, “Tunable Stiffness Scanning Microscope Probe,” Optics East, Philadelphia, Pa., October, 2004 T. El-Aguizy, J-h Jeong, Y. B. Jeon, W. Z. Li, Z. F. Ren and S. G. Kim, “Transplanting Carbon Nanotubes,” Applied Physics Letters, Vol. 85, No. 25, P. 5995, 2004 In-Plane AFM Probe with Tunable Stiffness, Clemens Mueller-Falcke, Soohyung Kim, Sang-Gook Kim, MIT, Intelligent Microsystems Center. U.S. Pat. No. 6,706,203 Barth, et al. Mar. 16, 2004 U.S. Pat. No. 6,862,924 Xi, et al. Mar. 8, 2005 U.S. Pat. No. 6,218,086 Binnig, et al. Apr. 17, 2001 United States Patent Application 2006/0172283 United States Patent Application 2006/0057585

### SUMMARY OF THE INVENTION

The instant invention has several embodiments and applications. A main embodiment of the invention discloses novel integration of gaming software with a scanning probe microscope or nanomanipulator. The present invention relates to embodiments where a scanning probe microscope or nanomanipulator is used in a gaming system by users. Sample substrate components or associated objects can be manipulated and interacted with by a user for playing games. Atomic, molecular and nanoparticle objects can be images and used by gaming software as pieces or elements in a game, treasure hunt, contest, betting or lottery. Various applications for nanoscale board game and electronic computer game interactions with scanning probe microscope substrate states and assemblies can be used for consumer electronics embodiments in devices for education and entertainment purposes. An attractive embodiment of a particularly useful design for the SPM manipulator of the present invention can provide MEMS or NEMS based inertial stick slip and walking sample and or probe motion. As well as scanning probe cantilever scanning operations in MEMS or NEMS form for large area scanning. A unique embodiment of the invention integrates a scanning probe capable of making both actuating operations on a sample substrate and driving at least one probe scanner tip for imaging and nanomanipulation. The advancement of MEMS/NEMS based actuation and scanning probes, logically leads to embodiments where the scanner with the probe moves semi-autonomously or autonomously over a sample. Thus the MEMS/NEMS based actuator drives the scanner over the stationary object. Multiple robotic embodiments of the device can operate in concert on a surface or surfaces. In general the main embodiment of the invention is for a MEMS/NEMS based planar derivative of the popular Besocke type Scanning Tunneling Microscope and also a derivative embodiment where the scanner is moved as a walker instead of the sample being inertially moved. The invention discloses novel integration of gaming software with a scanning probe microscope or nanomanipulator. The invention also embodies expressions where a combined actuator and probe means can be used in a compound cantilever to drive the scanner and probe over a stationary or moving sample substrate, effectively providing a mobile drivable device which can image and manipulate surfaces and substances with nanoscale and atomic level resolution. A further embodiment uses the device as a stepper motor for both linear and rotational motion of objects. Though the preferred embodiment uses piezoelectric actuation, any art recognized actuation and sensing means comprising electrostatic, magnetostrictive, thermal mechanical or shape memory allow means can be used to form the compound cantilever of the present invention. Piezoelectric bimorph and multimorph actuators are well known in the engineering and research science fields for high resolution actuation and sensing. In particular Scanning Probe Microscopes use piezoelectric actuators to scan sharp tips over or in proximity to sample materials. Piezoelectric stacks comprising alternating conductive metal pads and piezoelectric layers generate motion when an electric field is applied across the piezoelectric material. Alternately minute motions or vibration changes in a mechanical structure can be sensed with a piezoelectric sensor. A stack comprised of a metalpiezo-metal-peizo-metal can perform bending, extension and contraction motions. By fusing two parallel rectangular stacks composed of metal-piezo-metal-piezo-metal into a single cantilever three dimensional scanning can be performed.

Other actuation methods can be used for the invention instead of the piezoelectric effect. As said above, essentially some embodiments of the invention can be used as a means to form and operate a planarized Besocke type scanner where multiple piezo elements combined with scanner tips are operated so as to afford a means for XYZ sample or scanner motion. The one embodiment of the instant invention uses an assembly of two rectangular stacks composed of metal-piezo-metal-peizo-metal piezo multimorph structures for each probe tip actuator leg. Preferably one of the embodiments of interest combines both inertial actuation and probe tip scanner into one structure and uses dual probe scanner/sample actuators. These dual-mode cantilevers are fabricated or arranged so that three or more of the devices are operated in parallel and make contact with a sample. Each probe also contains a contact bump or tip which is located at the folding region of the compound cantilever. The contact bump, microsphere or tip is used to move a sample substrate over the scanner. Arrays of cantilevers can be fabricated also. Horizontally and or vertically oriented cantilever actuators can be used though horizontal fabrication is depicted. Still another object of the present invention is to provide means for forming complex rotational motors, nanomanipulator probe effectors, measurement and fabrication devices. By operating one or more of the actuator probe nanomanipulators with a captured or integrated object in the interaction gap between the probe tips, complex manipulation, fabrication and assembly steps and systems can be formed and controlled. Spherical spool type objects are one form of object especially useful for this embodiment as 5 or more degrees of freedom of motion can be actuated and used for such systems. In particular spool type objects with nanotube, DNA/RNA/Proteins or hybrid nanobiological, nanoparticle and nanomechanical objects and systems can be formed characterized and manipulated using spools to move, interact and store materials and information. One embodiment of special interest is the use of spooled nucleic acid molecules comprised of genes and chromosomes stored in spool form which are loaded into the actuator device and used for purposes comprising fabrication, replication, analysis and editing/recombination of genetic material and systems. Spooled material such as data storage media can be stepped or translated through the device for reading, recording and editing.

In Summary, the Probe of the Present Invention has the Following Advantages:

Application of scanning probe microscopy and nanomanipulation to electronic game playing. The cantilever with one or more probe for imaging can be used sequentially or simultaneously as both an actuator to move a sample substrate and as a means for moving the probe to scan the surface. Low area scanning of the probe scanner and large area scanning and tracking of the sample can be performed by a single device fabricated on an integrated MEMS/NEMS substrate, Sample substrates can be moved over centimeter range in X and Y axis and rotated continuously with nanometer lateral and micro radian resolution The scanner can be actuated so as to move relative to the sample substrate as a roving SPM Nan manipulator scanner device. When the sample substrate is actuated the probe tip can be automatically retracted from interaction or damage from the surface the device can form a compact device especially useful in nanotechnology applications in tight places in particular the small sample stages of electron microscopes such as TEM and STEM allowing atomic resolution electron beam and SPM microscopy and Nan manipulation Wafer level integration of arrays of the novel compound cantilever devices can be operated in parallel to move and manipulate sample substrate and afford a means for nanomanipulation, measurement, characterization, fabrication and data storage. Preferably, chemically functionalized nanotube tips can be attached to the apex of one or more of the probes. Integration of optical devices comprising waveguides, surface plasmon resonance, diodes, lasers, nanoparticles, and nanoshells can be used for optical interaction within the devices and between the probes and sample. The instant invention provides embodiments where the dual function MEMS/NEMS scanner actuator mechanism is integrated with a mass spectroscopy measurement device.

### BRIEF DESCRIPTION OF THE DRAWINGS

FIG. 1 is a schematic perspective view of the layer deposition used for one the compound lever piezoelectric multimorph elements of the actuator-scanner.

FIG. 2 is a crude side schematic view of a cantilever portion of the scanning probe actuator-scanner MEMS/NEMS device with a probe tip and microsphere contact for linear and inertial stick slip actuation of the sample substrate or scanner.

FIG. 3 is a diagram representing the sample substrate and microsphere contacts used to linearly and inertially actuate the sample stage or scanner in a similar manner to a Besocke scanner but in a planar MEMS/NEMS form.

FIG. 4 is a cross sectional view of the multimorph piezo cantilever and sample substrate.

FIG. 5 is a top down view of the multimorph piezo cantilever and sample substrate.

FIG. 6 is a top down view of the quad probe and actuator multimorph piezo cantilever and sample substrate MEMS/NEMS.

FIG. 7 is a diagram view of part of the probe modulation sequence used in an embodiment to form a rotational motor, spool cassette drive or nanomanipulator.

FIG. 8 is a diagram view of the continued probe modulation sequence used in an embodiment to form a rotational motor, spool cassette drive or nanomanipulator.

FIG. 9 is a diagram view of the continued probe modulation sequence used in an embodiment to form a rotational motor, spool cassette drive or nanomanipulator.

FIG. 10 is a set of diagrams depicting rotational nanostepper spooling and cassette applications with nanopores and probe arrays with DNA/RNA or nanophase materials.

FIG. 11 depicts a gaming, erector set and nanolithography embodiment.

FIG. 12 depicts a six cantilever implementation of the invention in the walker mode which can operate in inertial as well as non-inertial actuation of sample substrate.

FIG. 13 depicts an embodiment of the invention where the scanner probe cantilever and sample substrate actuator are separate structures.

FIG. 14 depicts an embodiment where the cantilever structures form a set of tweezers.

FIG. 15 depicts an embodiment where vertically oriented cantilever structures form a set of tweezers.

### DETAILED DESCRIPTION OF DRAWINGS

### Best Mode for Carrying out the Invention

In general, a scanning probe of the present invention allows the combination of Atomic Force Microscopy (AFM) and various modes of Scanning Probe microscopy of which there are dozens known in the art which may be adapted to the cantilever configuration of the present invention. It should be noted that various cantilever probe sensing mechanisms can be used such as electrostatic, piezoelectric, tunneling, optical quadrature, fiberoptic, interferometer, SQUID or any mechanism useful for nanometer to sub-Angstrom level resolution. Preferably the device is fabricated using MEMS fabrication using Piezoelectric actuation films deposited on SOI-Silicon wafers. Use of Sputtering or plasma deposition of ZnO or similar piezo films known in the art can be used or preferably sol-gel deposition of PZT type piezoelectric films can be performed to form the actuator on the compound lever cantilever. The patterning method is preferably optical lithography either using contact or projection lithography. Alternate lithography methods comprising electron beam or X-ray lithography can be used also.

The metal layers consist of Pt/Ti 200 nm/20 nm fabrication process flow:

(a) Thermal SiO2 growth and creating a SiNx KOH backside mask

(b) Pt/Ti bottom electrode lift-off

(c) Bottom PZT deposition and annealing

(d) Bottom PZT wet etch patterning

(e) Pt/Ti middle electrode lift-off

(f) Top PZT deposition and annealing

(g) Top PZT wet etch patterning

(h) Pt/Ti top electrode lift-off

(i) Si backside KOH and RIE release etch.

Initially, 200 nm thermal oxide is grown on both sides of Si wafer. Second, 200 nm silicon nitride layer is deposited on backside via PECVD and then patterned to form a hard-mask for a KOH backside etching later. A 200/20 nm Pt/Ti layer is then evaporated on the substrate and patterned via liftoff.

Lift-off permits the separated bottom electrode to be defined in a facile way because the Pt film is not easy to etch using RIE or a wet etching process. The PZT solution for the Sol-Gel film can be obtained commercially from (Mitsubishi Materials Corporation or other companies) or made in a lab by a chemist. Other Piezoelectric films can be used as known by those skilled in the art. The PZT Sol-Gel solution is subsequently spun on to the substrate at 500 rpm for 3 secs and 3000 rpm for 30 secs. The precursor gel film is pyrolyzed at 350° C. for 5 mins on a hot plate in several repeated step to create a PZT layer with 0.5 um thickness. Depending upon device scale, thicker or thinner films can be deposited to form the actuators of the MEMS device. The PZT film is then annealed at 700° C. for 15 mins. The piezoelectric and oxide membrane layers are patterned via wet-etching with an HCl: BOE (7:1): DI water (volume ratio of 100:16:200) etchant for 2 minutes.

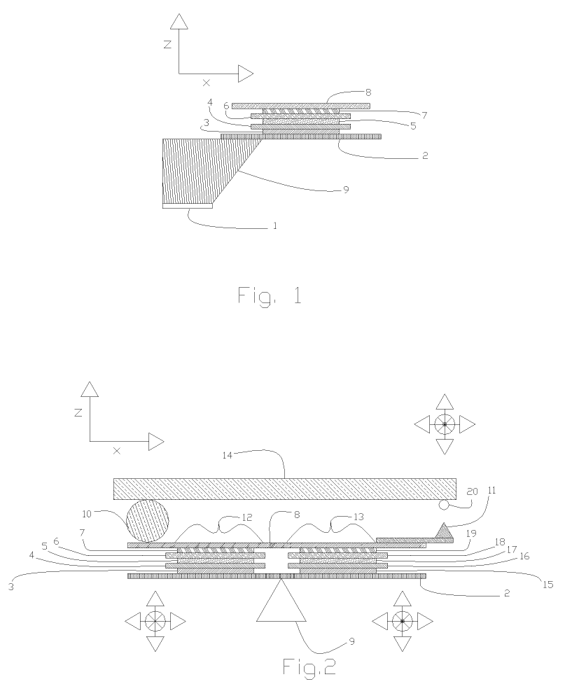

The PZT film can be etched before annealing at 700° C. in order to avoid the PZT crack problem if the ditch on the bottom electrode is wider than 3 μm. The top electrode deposited with second 200/20 nmPt/Ti evaporation and lift-off procedure. The cantilever membrane is then created with a 445 μmKOH backside etch, and finally released with a 5 μm Si RIE. During the KOH backside etch, the front surface is covered with Apeizon wax to protect any KOH attack on the PZT layer. FIG. 1.

1. Layer 1 Thermal SiO2 growth

2. Layer 2 SiNx KOH

3. Layer 3 Pt/Ti bottom electrode lift-off

4. Layer 4 Bottom PZT deposition and patterning

5. Layer 5 Pt/Ti middle electrode lift-off

6. Layer 6 top PZT deposition and patterning

7. Layer 7 Pt/Ti top electrode lift-off

8. Layer 8 Top Protective SiNx

9. Layer 9 Silicon substrate

For good planarity of the cantilevers surface strain compensation layers can be added to compensate for intrinsic strain asymmetry in the multilayer piezo stack. In addition extra inert protective layers such as glass, plastic, ceramic, ect can be added for operation of the piezoelectric PZT in aqueous and extreme chemical environments for extended periods of time. Fabrication methods for the sample substrate 14 in the form of an ultrathin silicon membrane can be found in Ultra-Thin Silicon Chips for Submillimeter-Wave Applications, R. B. Bass,1 J. C. Schultz,1 A. W. Lichtenberger,1 R. M. Weikle, 1S.-K. Pan,2 E. Bryerton,2 C. K. Walker3, 1—University of Virginia, Charlottesville, Va., 2—National Radio Astronomy Observatory Charlottesville, Va., 3—University of Arizona, Tucson, Ariz. found at Virginia semiconductor website at www.ece.virginia.edu/uvml/sis/Papers/rbbpapers/stt04.pdf. I Thin wafers and membranes are commercially available as substrates.

Operation of the Piezoelectric Multimorph:

FIG. 1 shows the cross section of a piezo bimorph of the cantilever. By generating an electric field between electrodes 3 and 5 the piezo element 4 will either contract or expand, depending upon the polarity of the field. The field between electrodes 5 and 7 will modulate the expansion and contraction of piezo element 6. By generating various field polarity relations between the electrodes, flexure, linear expansion and contraction of the beam can be generated. For instance by generating a expansion of piezo 4 and a contraction of piezo 6 the beam will up in the z axis. Opposite conditions will cause the beam to bend down in the z axis. By applying the same amount of expansion in both piezo elements 1 and 2 the beam will expand along the x axis. By applying the same amount of contraction in both piezo elements 1 and 2 the beam will contract along the x axis. FIG. 2 represents a simplified example of the dual use cantilever structure which can both move the sample substrate 14 and scan the tip 11 over sample object 20. Alternately the MEMS/NEMS cantilever scanner and actuator can be moved over the sample. It should be noted that this represents only 1 element of the actuator system and that at least 3 such actuator scanners would be required to provide scanning and support to sample substrate 14. The object 9 represents the substrate on which the piezo scanner is fabricated and the triangle is a gross representation of the nature of the pivotal structure of the folded compound cantilever which is better depicted in FIG. 5. The actuator and tip scanner makes contact with the sample substrate 14 by micro sphere 10 for linear and inertial displacements of object 14, One novel part of the design is that piezo bimorphs 12 can be bent up in the z axis and this will cause the tip 11 to move away from interaction with sample substrate 14 surface and object 20. This is of use because when linear or inertial stepping of the piezo 12 is used to move the sample substrate 14 the tip can be kept clear of surface interaction during rapid sample actuation of wanted. This can protect the tip and sample from damage. The piezo element 13 can be used to bend the tip toward the sample substrate 14 and perform feedback mediated scanning and nanomanipulation operations as with standard scanning probe microscopes. During linear or inertial stepping it is generally preferred that three of the contact points microspheres 10,40,41,42 be touching the sample substrate 14. Oscillating the bimorphs in an array of scanner actuator so that different microspheres make contact intermittently during actuation can be useful in transferring ware to all of the contact points in the array. Alternately all of the contact points microspheres 10,40,41,42 can be actuated and in contact with the substrate 14. The contact points microspheres 10,40,41,42 can be used to gain tracking information of the surface 14 during actuation via measurement of interaction between the contact points micro spheres 10,40,41,42 and sample surface 14. Magnetic, electrical, van der Val's, optical, physical or chemical features can be generated and sensed for tracking of the sample substrate 14.

1. Layer 1 Thermal SiO2 growth

2. Layer 2 SiNx KOH

3. Layer 3 Pt/Ti bottom electrode lift-off

4. Layer 4 Bottom PZT deposition and patterning

5. Layer 5 Pt/Ti middle electrode lift-off

6. Layer 6 top PZT deposition and patterning

7. Layer 7 Pt/Ti top electrode lift-off

8. Layer 8 Top Protective SiNx or SiO2

9. Layer 9 Silicon substrate

10. Microsphere or contact area Integrated with MEMS or post fabrication deposition

11. Layer 10 Silicon or metal (TiPt) deposition for tip

12. Piezo Bimorph Element

13. Piezo Bimorph Element

14. Sample substrate thin Silicon membrane or Composite

15. Layer 11 Pt/Ti bottom electrode lift-off

16. Layer 12 Bottom PZT deposition and patterning

17. Layer 13 Pt/Ti middle electrode lift-off

18. Layer 14 top PZT deposition and patterning

19. Layer 15 Pt/Ti top electrode lift-off

20. Sample material or object on substrate

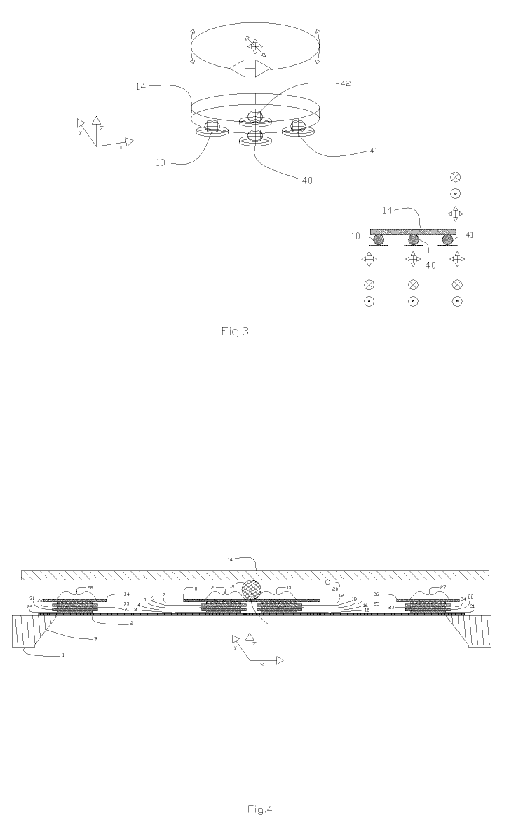

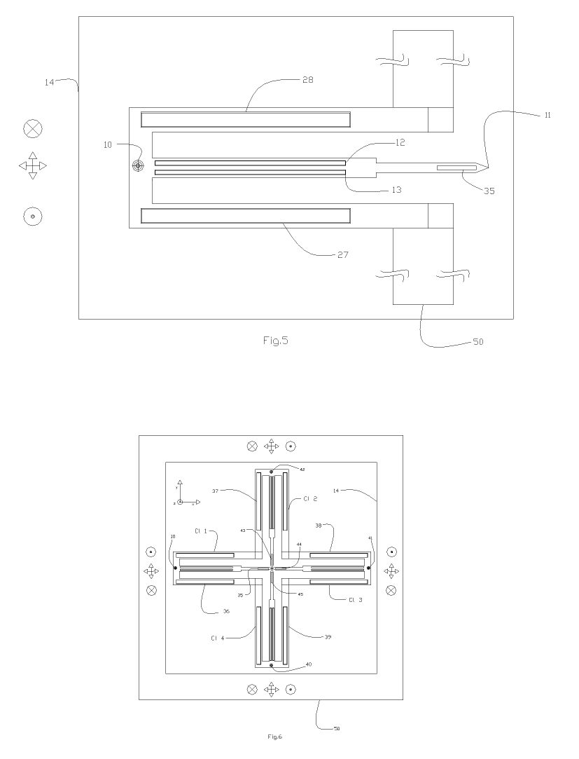

FIG. 3 represents a simplified diagram of the movements of the linear and inertial actuation sample substrate 14. None of the piezo elements and scanner probe tips and cantilevers are not shown. The arrows indicate the motions each actuator can impel the sample plate 14. Those familiar with the operation of a Besocke Scanning tunneling microscope scanner will instantly see the similarities to the operation of this planar MEMS version derived from the standard Piezo tube Besocke type scanner. The microspheres or contact areas 10,40,41,42 transmit linear and impulse actuation signals to the sample substrate 14. Rapid pulses sent to the piezo elements which drive the contact areas 10,40,41,42. The piezo actuators shown in subsequent diagrams and figures can be used to give the sample substrate plate 14 motion in the X,Y,Z, theta and rotation about the Z axis thus affording 5 degrees of freedom (5 DOF) actuation. The microspheres or contact areas 10,40,41,42 can be replaced after ware or changed to alter the surface properties of the contact area. Use of means comprising microtweezers, optical traps, lithography or molecular recognition functionalization are art recognized means for replacing microspheres or contact areas 10,40,41,42. Alternately, the scanner can be placed in an electron microscope or in the case where the scanner is operated in an electron microscope or focused ion beam milling machine, electron beam deposition can be used to repair, replace or modify the microspheres or contact areas 10,40,41,42. FIG. 4 represents a cross sectional slice through the complete preferred piezo multimorph element comprising a compound cantilever integrated probe-scanner-actuator. In this view the cantilever in 3D would extend out of the page. Three or more such cantilevers would be required to form a planar Besocke type scanner used to linearly and inertially actuate and scan sample substrate 14. The piezo bimorph element 35 is not shown in this cross section but is depicted in FIG. 5.

1. Layer 1 Thermal SiO2 growth

2. Layer 2 SiNx KOH backside mask

3. Layer 3 Pt/Ti bottom electrode lift-off

4. Layer 4 Bottom PZT deposition and patterning

5. Layer 5 Pt/Ti middle electrode lift-off

6. Layer 6 top PZT deposition and patterning

7. Layer 7 Pt/Ti top electrode lift-off

8. Layer 8 Top Protective SiNx or SiO2

9. Layer 9 Silicon substrate

10. Microsphere or contact area Integrated with MEMS or post fabrication deposition on cantilever CI 1

11. Layer 10 Silicon or metal (TiPt) deposition for tip

12. Inner Piezo Bimorph Element

13. Inner Piezo Bimorph Element

14. Sample substrate thin Silicon membrane or Composite

15. Layer 11 Pt/Ti bottom electrode lift-off

16. Layer 12 Bottom PZT deposition and patterning

17. Layer 13 Pt/Ti middle electrode lift-off

18. Layer 14 top PZT deposition and patterning

19. Layer 15 Pt/Ti top electrode lift-off

20. Sample material on substrate

21. Layer 16 Pt/Ti bottom electrode lift-off

22. Layer 17 Bottom PZT deposition and patterning

23. Layer 18 Pt/Ti middle electrode lift-off

24. Layer 19 top PZT deposition and patterning

25. Layer 20 Pt/Ti top electrode lift-off

26. Layer 21 Top Protective SiNx or SiO2

27. Outer Piezo Bimorph Element

28. Outer Piezo Bimorph Element

29. Layer 22 Pt/Ti bottom electrode lift-off

30. Layer 23 Bottom PZT deposition and patterning

31. Layer 24 Pt/Ti middle electrode lift-off

32. Layer 25 top PZT deposition and patterning

33. Layer 26 Pt/Ti top electrode lift-off

34. Layer 27 Top Protective SiNx or SiO2

35. Small apical bimorph on cantilever CI 1

36. cantilever CI 1

37. cantilever CI 2

38. cantilever CI 3

39. cantilever CI 4

40. Microsphere or contact area Integrated with MEMS or post fabrication deposition on cantilever CI 4

41. Microsphere or contact area Integrated with MEMS or post fabrication deposition on cantilever CI 3

42. Microsphere or contact area Integrated with MEMS or post fabrication deposition on cantilever CI 2

43. Small apical bimorph on cantilever CI 2

44. Small apical bimorph on cantilever CI 3

45. Small apical bimorph on cantilever CI 4

46. Microsphere or spindle

47. Computing device

48. Gaming algorithm

49. Input output interface depicted for Object 50 represents a MEMS/NEMS package

50. MEMS/NEMS Chip package

51. Contact point or microspheres similar to object 10

52. Contact point or microspheres similar to object 10

53. Contact point or microspheres similar to object 10

54. Contact point or microspheres similar to object 10

55. Contact point or microspheres similar to object 10

56. Contact point or microspheres similar to object 10

57. Is a user input output interface which can be a gaming joy-stick or controller device and or haptic force feedback input output system, gaming joysticks, prior art and new interface accessories can be plugged into computer 47 The two outer piezo bimorph elements 27 and 28 are used to bend or vibrate the piezo bimorph elements 12 and 13 and cause microsphere or contact area 10 to contact or disengage from contact with sample substrate 14. Equal expansion of piezo bimorph elements 27 and 28 causes tip 11 to move in the axis away from the other tips. Contraction of piezo bimorph elements 27 and 28 causes tip 11 to move toward the other tips. Bending piezo bimorph elements 27 and 28 up toward the substrate 14 in the +z axis causes the microsphere to lift the sample substrate 14 in the z axis and also simultaneously causes the tip 11 to move in the −z axis away from the sample substrate 14. This is especially convenient in that it protects the tip and sample from scratching or damaging one another during linear or inertial movement of the sample substrate or scanner. Expanding piezo bimorph 27 and contracting piezo bimorph 28 will cause the tip to move in the −x axis, expanding piezo bimorph 28 and contracting piezo bimorph 27 will cause the tip to move in the x axis. By modulating the bending of the whole cantilever the microsphere or contact area 10 can be in contact or spaced from contact with sample substrate during these motions. For additional range, complex actuations or independent motion piezo bimorphs 12 and 13 can be operated in concert with piezo bimorph 27 and 28. By bending piezo bimorph 27 and 28 down in the −z axis to disengage microsphere 10 from contact with sample substrate 14 the cantilever portion of piezo bimorph 12 and 13 will be forced up in the +z axis and the tip 11 will come into contact with sample substrate 14. To modulate the contact force and or spacing of tip 11 with sample substrate 14 a feedback signal is sent to piezo bimorph 12 and 13 causing them to bend in the −z axis.

The magnitude of the bending can be modulated in order to simultaneously keep the cantilever tip in scanning interaction with sample substrate 14 and keep microsphere 10 out of contact with sample substrate 14. Piezo bimorph 35 can be used to further actuate the tip 11 in the z and y axis. Because the piezo bimorph 35 is much smaller than the other bimorphs in the cantilever it can operate at much higher frequencies. Some modes of operation can use the contact of microsphere 10 with sample substrate 14 as a means of dampening vibrations and modulating the cantilever vibration behavior but generally a free space between microsphere 10 and sample substrate 14 during scanning of tip 11 will be used during tip scanning actuation.

FIG. 5 represents a top view of the multimorph cantilever shown in FIG. 4. It the tip 11 can be a single or multiple tip structure. Nanotweezer formation can be placed at the apex and can be driven preferably by piezoelectric or electrostatic forces. Electron beam deposition, anisotropic etching of silicon or formation of nanotubes can for the tip or tips.

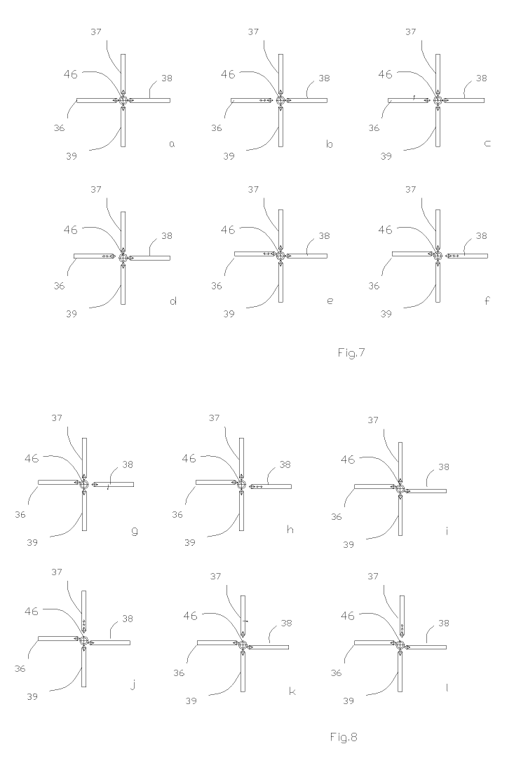

FIG. 6 represents a quad cantilever array MEMS/NEMS configuration of the instant invention. It should be noted that the representation does not depict the contact pads on input output lines or MEMS/NEMS packaging peripherals. In addition the device can be packaged or cut with multiple quad cantilever SPM Nan manipulator probe dies or it can be packaged as a wafer level integration MEMS/NEMS system. In one possible mode of operation. CI 1, CI 2 and CI 3 are initially sent signals to polarize their piezo bimorphs causing them to bend up in the +z axis. This causes a state where microspheres 10, 42 and 41 are in contact with sample substrate 14 in the +z axis causing sample substrate 14 to be lifted in the +z axis. CI 4 is sent electrical signals so as to polarize the piezo bimorph on it to bend such that microsphere 40 moves in the −z axis and it's scanner tip moves in the +z axis until it contacts, taps or makes a nanometer scale interaction for scanning probe interaction measurement with sample substrate 14. A short range raster scan can be performed by cantilever CI 4 to map and analyze a region of sample substrate 14.

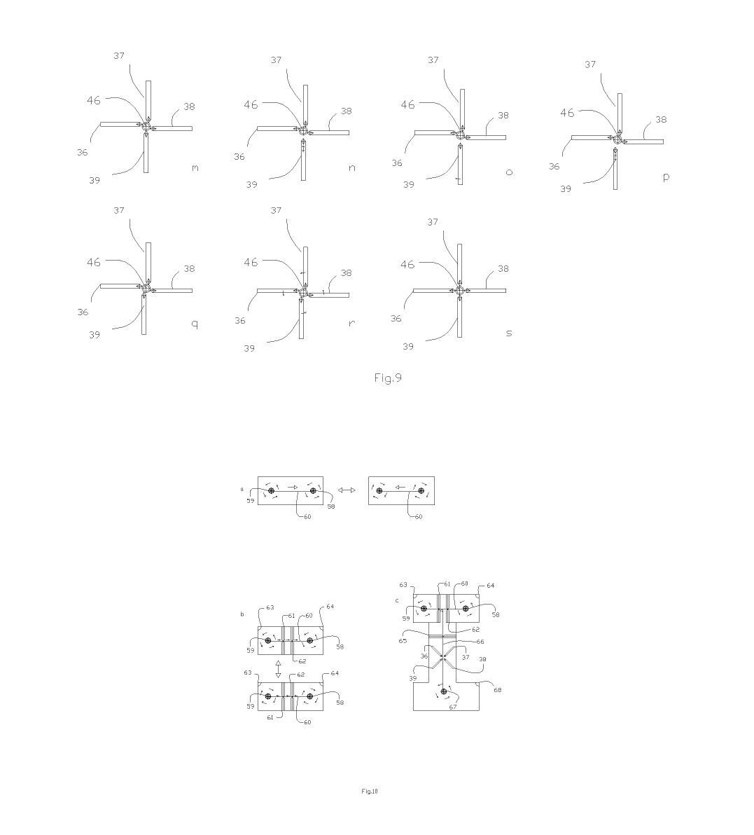

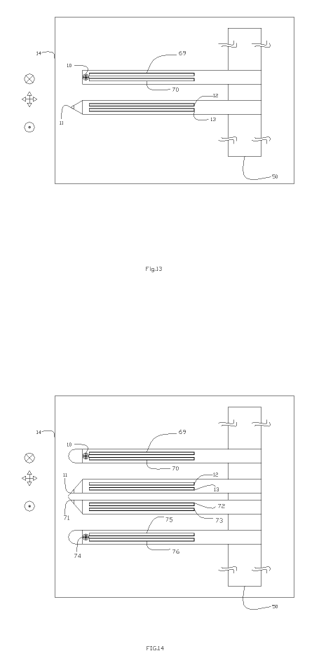

By sending the following signals to the corresponding cantilevers a linear scanning process can be carried out, effectively increasing the scan area size without resorting to inertial stick slip actuation. CI 1 is contracted and microsphere 10 in contact with sample substrate 14 is displaced in the +x axis, CI 2 is bent in the +x axis by expanding one outer piezo bimorph and contracting the other causing microsphere 42 to move sample substrate in the +x axis, CI 3 has it's outer piezo bimorphs expanded such that microsphere 41 is displaced in the +x axis. By sending the following signals to the corresponding cantilevers a linear scanning process can be carried out, effectively increasing the scan area size without resorting to inertial stick slip actuation. CI 1 is expanded and microsphere 10 in contact with sample substrate 14 is displaced in the −x axis, CI 2 is bent in the −x axis by expanding one outer piezo bimorph and contracting the other causing microsphere 42 to move sample substrate in the −x axis, CI 3 has it's outer piezo bimorphs contracted such that microsphere 41 is displaced in the −x axis. By sending the following signals to the corresponding cantilevers a linear scanning process can be carried out, effectively increasing the scan area size without resorting to inertial stick slip actuation. CI 2 is expanded and microsphere 42 in contact with sample substrate 14 is displaced in the +y axis, CI 1 is bent in the +y axis by expanding one outer piezo bimorph and contracting the other causing microsphere 10 to move sample substrate in the +y axis, CI 3 is bent in the +y axis by expanding one outer piezo bimorph and contracting the other causing microsphere 41 to move sample substrate in the +y axis. By sending the following signals to the corresponding cantilevers a linear scanning process can be carried out, effectively increasing the scan area size without resorting to inertial stick slip actuation. CI 2 is contracted and microsphere 42 in contact with sample substrate 14 is displaced in the −y axis, CI 1 is bent in the −y axis by expanding one outer piezo bimorph and contracting the other causing microsphere 10 to move sample substrate in the −y axis, CI 3 is bent in the −y axis by expanding one outer piezo bimorph and contracting the other causing microsphere 41 to move sample substrate in the −y axis. In order to cause step displacement of sample substrate 14 in the above directions by inertial stick slip actuation short voltage pulses of the above corresponding bending mode actuations are applied to their respective piezo bimorphs. Step size is determined by the voltage. Low voltages can tend to cause stiction and failure to move so a minimum repeatable voltage should be measured which corresponds to a small fraction of the linear scan field of the piezo scanner. Object 50 represents a MEMS/NEMS package enclosure which is, in this particular embodiment a removable chip that plugs into a input output interface depicted in FIG. 12 as object 49 which is preferably plugged into computer interface 47. For general purpose use as a research instrument computer interface 47 can run art recognized commercial SPM and nanomanipulation software, Labview or custom software, machine code microcontroller or custom digital signal processor and graphical user interface software. This is an alternative to the gaming software package used in FIG. 12. Tracking and drift compensation can be carried out as is done in Besocke type STM scanners. Generally because the thermal expansion coefficients of the actuators are matched drift is minimal. It should be noted that adding ramp structures or steps on substrate 14 will allow large alterations in z axis movement of objects as is performed in traditional Besocke STM scanners. FIGS. 7, 8, and 9 represent a sequence of probe movements orchestrated for the purpose of rotating an object in the gap space between the quad cantilever and tip device. The operations can be seen as a Nan manipulator operation or as a nanostepper motor for rotation of nanoscale and microscale objects. Coupling the rotating object to other electrical, mechanical, chemical, NEMS, MEMS, sensor, actuator, processor or system can be used form many purposes obvious to those skilled in the art. The rotating object is preferably a chemically functionalized polymer microphere or nanodot commercially available form Sigma-Aldritch or other biochemical companies. Preferable art recognized reversible bonds such as disulfide or avidin-streptavidin functionalization is used to link objects to the object 46. Preferably a radially symmetric object such as a sphere or spindle is picked up or placed in the open junction gap between cantilevers CI 1, CI 2, CI 3 and CI 4 which are 36,37,38 and 39 respectively. In going from state a to b the cantilever 36 is retracted from the object 46 then is moved radially clockwise to state c then actuated in step d and brought into contact with object 46 to reach state e. Next going from state e to f the cantilever 38 is retracted from the object 46 then is moved radially clockwise to state g then actuated in step h and brought into contact with object 46 to reach state i. Next going from state i to j the cantilever 37 is retracted from the object 46 then is moved radially clockwise to state k then actuated in step l and brought into contact with object 46 to reach state m. Next going from state m to n the cantilever 39 is retracted from the object 46 then is moved radially clockwise to state o then actuated in step p and brought into contact with object 46 to reach state q. Finally cantilevers 36,37,38 and 39 are all radially actuated counter-clockwise in step r which results in object 46 being rotated and ending in state s which is the same position and state as in state a except for a single counterclockwise rotational translation step. The cycle can be repeated or reversed as by user or algorithm requirements or feedback. It should be noted that at intermediate steps in the process the probes, sample substrate 14 or other means may be used, modified, measured or interacted with object 46 and what it interacts with. It should be noted that the above states of cantilevers and rotating object 46 can be used to dither or linearly actuate the rotation in a reversible manner in sub-step increments. This is important in high resolution movement of nanocomponents and in particular polymers such as DNA/RNA, proteins, nanocomposites. Moving DNA/RNA on, over or through structures can be done with high resolution and reversibility with this mechanism. A particularly interesting embodiment uses the spool and motor structure as a genetic cassette mechanism. Feeding material to the spool device and threading the spooled material through structures and means comprising nanopores, pumps, elecrtoosmotic, electrolysis, electroporation, thermocapillary, dielectrophoretic, microfluidic channels, nanofluidic channels, reactor regions, combinatorial chemical arrays, cell cultures, in vivo environments, nanotweezers, nanotomb, sensors such as optical, chemical, electrophoretic, electrochemical, electrical conductivity or tunneling junctions, ect can be used to measure, synthesize, replicate, assemble combinatorial array and manipulate spooled material and those that interact with the spooling mechanism. By mounting the rotating object 46 to the substrate or cantilevers of MEMS/NEMS chip 50 using a rotational bearing such as a single chemical bond or a telescoped nanotube bearing a single probe tip can be used to rotate an object 46. It should be noted that arrays of cantilevers with three or more contact points with can be used for the rotation process. FIG. 12 represents a six cantilever scanning probe microscope Nan manipulator embodiment of the instant invention where non-inertial walking motion of the scanner or the sample substrate and can also be used for the process described in the above rotational sequence.

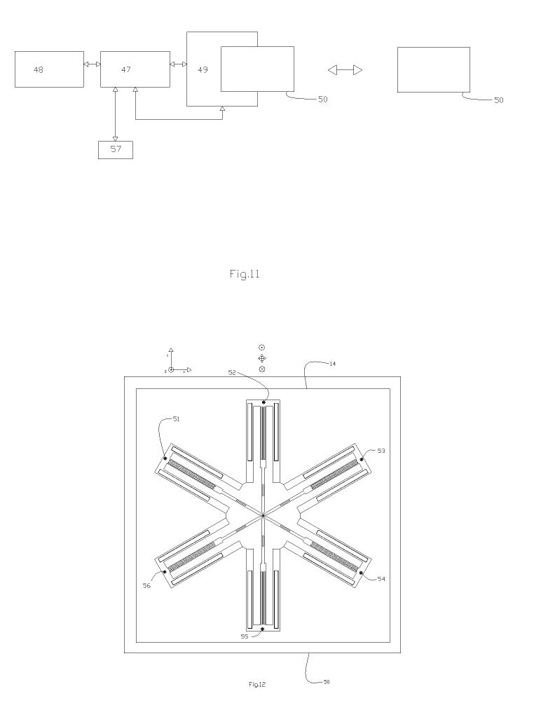

FIG. 10 depicts a microsphere or nanosphere spindle spool device which can be integrated with or loaded into the cantilever probe device of the instant invention. It can be operated by actuation sequences as described for FIGS. 7,8 and 9 are performed on multiple spool devices or related actuation methods. In the FIG. 10 (a) two spool devices are operated in parallel as a cassette mechanism. The rotary motor sequence depicted in FIGS. 7,8 and 9 are performed by the devices 58 and 59 on the right and left. Clockwise and counter clockwise spooling of the material wound on the spool can be used to transfer material from one spool to another or to change the tension on the spooled object. In a further embodiment seen in FIG. 10 (b) a pair of nanopore structures 61 and 62 have the spooled material 60 traverse them for scanning, data reading, data writing, transfer, synthesis or measurement purposes. Modulation of the nanopore structures is possible using actuators attached to the nanopore structures 61 and 62. The substrate on which the pores or substrate 50 are formed can have sensors comprising optical, electrochemical, tunneling, Raman, near-field optical, magnetic or plasmon resonance. In addition mechanical, channels, ect can be also formed to interact with material being spooled. The diagram 10b depicts two electrophoretic or electroosmotic electrodes 63 and 63. These electrodes are used to generate a potential to drive ionic materials through at least one nanopore such as 61 or 62. Alternately these electrodes can be used without a nanopore structure. The spool device can be reversed by modulating the sequence described in FIGS. 1 through 9. In particular FIGS. 7-9 can be operated in forward or reverse mode. In addition to rotational modes for spooling torsion modes of actuation can be performed. The probe actuator can also be moved in pure XY and Z axis modes in addition to rotational modes. The MEMS/NEMS device 50 can perform limited pure XY and Z axis actuation modes. By mounting the MEMS/NEMS device on an actuator system known in the art, larger actuation ranges can be achieved. FIG. 10c depicts one possible arrangement for a multiple spooling device. The device described in 10a and 10b is ported to a second branch of spooling for feed, capture and manipulation of material. Of particular interest is use for spooling the product of a replication fork or mixing two strands of nucleic acid molecules DNA, RNA or DNA/RNA hybrid structures and composites. Material 66 is a second strand of material which is drawn from a replication fork or hybridization interface. Higher order devices and strand structures such as Holiday junctions are obvious extensions of this design. Alternately nanotubes can be fed through the device in a splitting or splicing mode. Nanotubes with nanobearings incorporated into multiwalled nanotube can be used as object 60 or 66.

Material 66 is drawn through nanopore 65 and into the probe interaction zone formed by probes 36,37,38 and 39. Any number of probe can also be used instead of the quad probe arrangement depicted. Operation procedures and methods which combine the spool storage and manipulation with probe capture of molecular materials and analysis by mass spectroscopy can be used to measure mass of single and double stranded nucleic acids or other materials comprising molecules, viruses or nanoparticles. Operation of at least one probe such as any of probes 36,37,38 and 39 as an electrophoresis or separatory device as in United States Patent Application-20060172283 entails a novel combination of the instant invention MEMS/NEMS spooling stepper device and rapid probe tip based separator for sample measurement, manipulation and analysis. Art recognized processes such as transcription, translation and amplification can be carried out in conjunction with the afore mentioned combination. In addition potentials between two or more tips can be used to manipulate or characterize materials.

After the probe interaction zone there can be another spooling structure 67. At least one electrode 68 is placed in the downstream chamber containing probes 36,37,38, 39 and spooling device 67. Additional nanopores, SPM probes, sensors or notch structures can be added. Non-liquid, superfluid, gas, gel and vacuum operation of the spooling mechanism can be performed.

The nanomanipulator placed at the position depicted where probe objects 36,37,38 and 39 can be one or more probes attached to actuators as depicted in prior figures or a macroscopic SPM device. The probe can be operated so as to perform lathe operations on moving object material 65 which can be made to move linearly or in a rotational mode by the afore described actuators. By placing the device in a focused ion beam milling machine and or electron microscope high resolution observation and modification of structure can be performed. Laser irradiation and chemical reagent flow and or catalysts can be performed during manipulation steps to form highly intricate structures. Nanotube bearing and molecular mechanical structures can be integrated into object 65 before during or after milling or nanolathe nanofabrication work begins. Interface with mass spectroscopy analysis means is to be used as a characterization means for spooled and manipulated materials. It should be noted that various bioMEMS and bioNEMS applications with art recognized and new micro fluidic and nanofluidic structures can be implemented for bioinformatics, genomics and proteomics applications as well as nanomaterials development and processing. Integration of combinatorial chemical array structures with the spooling structure described will provide enhanced methods and applications for assembly, synthesis, analysis, diagnostic tests, research and engineering. Cloning of nucleic acid oligonucleotide, ribonucleotide and genome materials and interaction with the spooling device through linear, 2D or 3D arrayed genetic materials. FIG. 11 depicts a gaming, screen saver, erector set and nanolithography embodiment useful for consumer electronics applications. Because this embodiment has a MEMS/NEMS based SPM integrated with the user interface and the sample stage and tip approach is automated, novice applications in the gaming and entertainment industry is possible. Nanoscale simulation for gaming and education has not thus far been integrated with a low cost SPM nanomanipulator. In addition nanomanipulators for research have not been integrated with gaming purposes and are far too expensive for general gaming applications. Preferably an array of the scanner devices or scanner substrate pairs are fabricated on a single chip module so that if the a single device fails the software can use an alternate scanner or substrate. Though non-MEMS/NEMS based devices can be used the preferred embodiment is MEMS/NEMS based chip modules for low cost. Changeable substrates/MEMS scanners which can be loaded onto the scanner device are a variation of the device which will allow users variations in terms of substrate surface features and composition. In addition hermetically sealed modules can be changed by loading them into the object 49 which is preferably a USB or Firewire adaptor plug for plugging MEMS/NEMS chip 50 into a computer interface. Preferably object 49 has art recognized sample and hold capabilities and or Digital to Analog (DIA) and or Analog to Digital (A/D) signal generation and measurement capabilities. For a low cost implementation the object 49 accepts scanner drive signals from the computing device 47. Preferably the computer 47 sends 16 bit or greater output signals. This can be done digitally or analog via a soundcard with a DSP onboard. And said DSP can accept and process scanner signals from MEMS/NEMS chip 50 for feedback operation of the scanning probe microscope nanomanipulator. For certain video game operations internal DIA and A/D signals are generated on the MEMS/NEMS device 50 by art recognized circuit fabrication methods. An alternative is to integrate the device into a sound card or DSP chip module of a consumer electronics device using a flip chip bonding stack. The MEMS SPM scanner nanomanipulator is interfaced with a computer controller 47 which has a gaming algorithm 48 loaded into a memory storage device. The gaming algorithm 48 is programmed with known or new game rule sets using art recognized computer programming languages or new computer languages. Preferably C programming or Java based languages are used but machine coded digital logic, microcontroller, ASIC's or digital signal processor methods as well as a general purpose computer can be used. Preferably The scanner device is plugged into a USB port or the like in a users device or gaming system and uses the users existing computer processor to perform calculations and display hardware, although stand alone use can be done. It is also possible to plug the scanner into a mobile device such as a PDA or cell phone for user interface. Algorithms can be written or modified by users or loaded onto the memory storage device by direct loading by EEPROM, ROM, RAM, chip, SIM card, Digital Camera memory card, Digital Cell phone memory card, CD-ROM, DVD or the like. Alternately users can download gaming algorithms by modem or wireless network. Any games comprising such games as chess, checkers, mazes, bingo, treasure hunt, virtual characters, virtual communities, racing games, flying games, a lottery, dominos, go, cellular automaton, mahjong, trademarked popular board games or role playing games, ect can be loaded or stored on computer 47 and or gaming algorithm 48. Physical sample substrate 14 can have microscale, nanoscale, molecular or atomic entities which can be used as pieces or components of the game environment. Object 57 is a user input output interface which can be a gaming joy-stick or controller device and or haptic force feedback input output system, gaming joysticks, prior art and new interface accessories can be plugged into computer 47. In some embodiments a quantum mechanics computational calculating algorithm for interaction field modeling and user interaction response is operated in conjunction with or incorporated into the gaming algorithm 48. The computer can play the user or the user can play other users or a mixture of these modes can be loaded on program 48. Screen saver operations for graphic interface uses can use the SPM nanomanipulator information. Alternately scanning probe microscope topographic or physical images or maps can be used as display information for gaming either directly or in a derivative form in a virtual reality or processed virtual reality environment which uses algorithm, scanning probe microscope nanomanipulator and user data to form the mapped environment and or display/presentation. Using user interface computer 47 and the SPM nanomanipulator device of the invention via one or more such probes as probe 10, physical modifications to the scanned areas can be carried out by the user and or algorithm to change the board state. Integration of virtual reality games such as shooting games, driving, racing, flying games where users normally interact with a purely synthetic scenery and setting can be digitally amalgamated with interaction with the scanning probe microscope nanomanipulator device of the instant invention. Contests can be played or orchestrated using the interface individually or in groups using networks of the devices via loading appropriate algorithms into gaming algorithm 48. Crossword puzzles and normal puzzles can be loaded into the gaming algorithm 48 and depicted on the substrate 14 using assemblies of objects such as sample object 20. Users or marketers can load image files or general data into gaming algorithm 48 or computer interface 47 and have the SPM device of the present invention render their image or data in a nanoscale replica or connected processed digital form to the gaming environment interacting with the SPM nanomanipulator. Such actions comprise a means for having their data comprising, portrait, personal image, maps, cards, tickets, logo, 2D or 3D art work, sound, data, video or signature rendered using SPM nanomanipulation or appearing in the gaming environment. Users can exchange their data or physical copies of the information via wireless network, modem, or exchange of physical substrates 14. Real time user defined writing can be carried out and transmitted to other user systems over data exchange pathways. Obviously data encryption can be used to encode information for secure exchange of data between chosen users both at the software data exchange level and in encryption of the written inscriptions or marks, nanoassemblies or modifications made on substrate 14. Art recognized encryption techniques can be used as well as new encryption protocols.

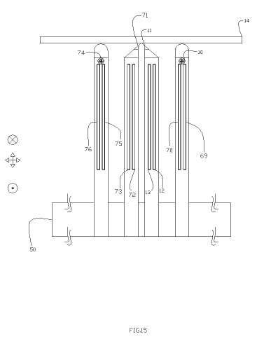

Text data can be represented in any language and replicated on the substrate 14 via art recognized use of keyboard encoding and printer driver type algorithms loaded onto gaming algorithm 48 or computer interface 47. Substrate 14, the scanner chip 50 or an associated flip chip can have a memory storage capability for storing data on the gaming substrate for exchange of any type general digital information comprising gaming state, songs, sound, images, pictures, user information, security information, authentication information, billing information, lottery data, algorithm execution information, game characters, points, qualities, virtual energy, apparel, auxiliary objects, maps, virtual vehicles, virtual real estate, or physical properties used in the gaming process, ect. Such storage allows for sale or trade of such assemblies and or states between market retailers and user as well as between user to user. Alternately or concomitantly, gaming subscribers or users can have character and gaming states stored in a remote site such as a network server. Updating the above information can be done using any communication means or data storage input output device but internet, wireless network or CD-ROM/DVD are preferred means. Preferably in some nanotechnology based gaming environments scientific quiz questions can be asked of the user as an educational teaching mechanism within the game. Nanoscale maps, countries, regions and cities and objects can be patterned on substrate 14 and used as reference settings or objects in relation to gaming algorithm 48. Gaming algorithm 48, computer 47 or a network computer can have art recognized ab initio quantum computation algorithms and or nanocad algorithms running on them to interact with users gaming state or be modified by the user in various ways. As stated above a preferred embodiment has the MEMS/NEMS chip is plugged into a USB or Firewire port for user interface with general purpose computer or gaming system use. A low cost solution for implementation of signal generation is to plug the MEMS/NEMS device into the sound card of a computer and use the digital signal processor and Digital to Analog and Analog to Digital conversion capabilities in a general purpose computer. But this will limit scan speed. Alternately the device may be plugged into gaming hardware currently sold or being developed in the gaming industry. Most gaming systems have multiple channels of input and output and high speed signal processing and display capabilities. Obviously object 57, input and output devices such as haptic force, gaming joysticks, prior art and new interface accessories can be plugged into computer 47 for real time user input and feedback interaction. Obviously multiple user interfaces 57 and types of interface can be used. User movement can be monitored and fed into the gaming process using art recognized methods described in the above reference articles. By having the MEMS/NEMS chip in the form of a removable USB type plug in module certain uses can be implemented where customers replacement of first generation chips can be performed if the scanner or surface fails after some time. In preferred embodiment the MEMS/NEMS chip or module 50 has a power supply and can continue to operate after the power to the host device is shut off for combinatorial processing applications. In other applications the combinatorial operations of chip 50 are run by the host computer in screen saver mode as a background process. Further more manufacturer or second or third party directed control of the combinatorial assembly or fabrication capabilities of the nanomanipulator MEMS/NEMS chip 50 can be carried out by wirelessnetwork, algorithm 48 or input to or from computer 47. Users should be able to form shared operations groups or rent out their nanomanipulation capabilities of their gaming equipment. Computer 47, interface 57, object 49 or MEMS/NEMS device 50 can preferably have a RFID or wireless communication circuit such as “Bluetooth” or the like to interact with objects the user presents to the game such as RFID enabled cards or object which are detected and effect gaming algorithm 48 in gaming processes or educational processed. As an alternative to this any digitally enabled pen, PDA or interface device can be used to effect algorithm and thus MEMS/NEMS probe device 50 and gaming algorithm 48. One application and embodiment of particular interest and use is attachment of one or more magnetic nanoparticle or microparticle to objects spooled on 46 in the above diagram. Flexible polymers or semi-rigid nanotubes or nanowires can be spooled on object 46 and have magnetic particles attached to them. By applying torque to the motor depicted in FIGS. 7,8 and 9, while a spool of material is wound or unwound from object 46 in conjunction with magnetic forces to a particle at the end of the reeled object, three dimensional modulation of the trajectory and placement can be achieved. It should be noted that using single scanner, scanner groups and massively parallel arrays of the above dual purpose scanner substrate actuator cantilevers novel nanotweezers and nanomanipulation means can be effectively carried out for manufacturing and research. CMOS integration of signal generation/measurement and Digital Signal Processing (DSP) can be carried out on the same substrate or using flip-chip or wafer scale integration and fabrication methods known in the art of microelectronics and MEMS/NEMS. For consumer market applications in particular a retainer spring or bracket will be added to hold the sample substrate in place or within close proximity for re-engagement should the device be inverted. Alternately a magnetic attraction force between the sample substrate and the scanner, bracket or chip package will be used to inhibit or control movement of the sample substrate relative to the scanner. Magnetic films, regions, objects or microspheres attached to the sample substrate can be used to modulate cantilever bending due to the weight of the sample substrate and modulate friction forces between surfaces. In addition such magnetic regions can be used for positioning, detection and movement of substrates. Magnetic particles or regions on the cantilevers of the scanner can be used to perform magnetically driven oscillation of cantilevers as well as force modulation known in the art of scanning probe microscopy. Higher frequency and unique sensing capabilities can be performed when only the end of the cantilever is driven in oscillation by magnetic, piezoelectric, optical, electrostatic, ect modes. The scanner may also be used in a mode where the probe tips are operated in any of the modes mentioned in prior art probe microscopy. The above use of magnetic material and fields can be applied to the spooled object 60 and or 66. FIG. 12 represents a six cantilever scanning probe microscope nanomanipulator embodiment of the instant invention where non-inertial walking motion of the scanner or the sample substrate. Besocke type inertial stickslip slide motion can be carried out using three actuators or more but use of this method is generally used in gas or high vacuum. The present invention can be used in liquid immersion environments. In the following figure a means for actuation is described which is an alternate to stick-slip slide type or inertial actuation motion. The cantilever actuators used in this figure are similar to those described in FIGS. 1 through 6 and can be operated in a similar fashion in terms of electrical signals sent and bending modes. The objects 51,52,53,54,55 and 56 are contact points or microspheres similar to object 10 in FIGS. 1 through 6 on the compound cantilever. Each cantilever has 2 external bimorph and 2 internal bimorphs as well as a high frequency bimorph as seen in the described designs of FIG. 1 through 6. For non-inertial actuation three of the six actuators are engaged with the sample substrate 14 while the other three are repositioned. Thus an actuation sequence example can start with cantilevers and microspheres attached to objects 51,53 and 55 in their state where the cantilevers actuating microsphere objects 51,53 and 55 are piezoelectric ally energized by electrical potentials bending the cantilevers in the −z axis and thus are not in contact with sample substrate 14. Objects 52,54 and 56 are piezo electrically energized such that they are in contact with sample substrate 14. By bending cantilevers attached to Objects 51,53 in the +y axis and contracting cantilever attached to object 55 in the +y axis and subsequently bending the three in the +z axis so as to contact sample substrate 14 a first cycle of the motion process is completed. Next the cantilevers attached to Objects 52,54 and 56 are piezo electrically energized such that they bend in the −z axis and retract from sample substrate 14. Next electrical potentials cause bending cantilevers of attached to Objects 54,56 in the +y axis and contracting cantilever attached to object 52 in the +y axis and subsequently bending the three in the +z axis so as to contact sample substrate 14. Next cantilevers attached to objects 51,53 and 55 are bent in the −z axis so as to not be in contact with sample substrate 14. This returns the cantilever network to the initial state. A repeat of the above cycle results in incremental actuation in the +y axis. For an example of actuation in the +x axis cantilevers attached to objects 51, 54 and 56 are bent in the −z axis so as to not be in contact with sample substrate 14. Cantilevers attached to objects 52,53 and 55 are in contact with sample substrate 14. Cantilevers attached to objects 51, 56 are bent in the +x axis and 56 is bent in the +x axis. Next the cantilevers 51, 54 and 56 are bent in the +z axis so as to be in contact with sample substrate 14. Next cantilevers actuating and attached to objects 52,53 and 55 are bent in the −z axis so as to not be in contact with sample substrate 14. The cantilevers actuating and attached to objects 52,53 and 55 are bent in the +x axis then bent in the +z axis until they make contact with sample substrate 14. Repeat of the above cycle is performed to cause incremental actuation in the +y axis. Arrays of the hex-cantilever device depicted can be formed on a single chip. In this case a sample substrate 14 can be actuated by having three or more microsphere or contact areas like 10, 51,52,53,54,55 or 56 supporting the sample substrate 10 and using any three or more cantilevers in the array to cycle through the above sequence for actuation. Alternately, arrays of the cantilever depicted in FIG. 13 can be used in a similar noninertial walking mode. Wafer level arrays with hundreds or thousands of the hex cantilever devices can be fabricated. By having multiple sample substrates like 14 moving over the wafer level array, complex processes such as manufacturing, processing or analysis can be performed. This device or the multiple tip probe device can preferably be placed in a electron microscope, Scanning Atom Probe or LEAP microscope for mass spectroscopy analysis of materials scanned by the SPM nanomanipulator. FIG. 13 represents an embodiment where the sample substrate actuator cantilever 23 and scanner cantilever and tip 11 are not coupled on MEMS/NEMS chip 50. Implementation of a Besocke type inertial scanner or walker type actuator MEMS devices described above with one or more of the depicted sample substrate actuators 23 can be implemented using the above described device but with the microsphere or contact area 10 can be used in non-coupled version of the actuation mechanisms described above. Preferably three or more cantilever actuators 23 and microsphere or small contact area 10 objects are used to move sample substrate 14. Though stationary sliding surfaces can be used with one or more cantilever actuators 23 and microsphere or small contact area 10 objects used to move sample substrate 14. Cantilever 23 and the tip driving cantilever have a pair of bimorph actuators 12,13,69 and 70. The function of these bimorphs is similar to that described in FIG. 1 through FIG. 9. This is an embodiment where the planar Besocke-like MEMS/NEMS actuation and scanning mode is performed by a decoupled set of cantilevers. FIGS. 14 and 15 represents vertically and horizontally oriented tweezers embodiment where the scanner actuation piezo and scanner probe actuators and not integrated as they are in FIG. 5. Dual contacts to the substrate 14 are depicted but 3 or more are actually used in the complete device for inertial or walking actuation. The operation of the cantilevers bearing tips 11 and 71 is the same as described in FIG. 13 and previous figures. The tips 11 and 71 can be used to pick up and manipulate objects as well as measure and characterize surfaces and objects on surfaces. In the gaming mode embodiment the tweezers can be used to write/read and manipulate board states of the game process according to gaming algorithm 48 and user input from local users or via wired or wireless network gaming players. Multiple copies of the structure depicted in FIG. 14 can be integrated on a surface of MEMS/NEMS 50 or be formed as walking devices that move over a surface using the above described inertial slider and walker methods Embodiments where the MEMS/NEMS device 50 has an array of cantilevers for actuation of the sample substrate 14 or multiple substrates as well as one or more scanning probe cantilevers with tips 11 and or one or more nanopore. Obviously the scanner or array of scanners can alternately be operated to walk or be inertially moved over the sample as opposed to the sample substrate 14 being moved. Methods for fabricating out of plane tip structures using anisotropic etching of silicon and fabrication of cantilever structures relevant to the instant patent can be found in “Si multiprobes integrated with lateral actuators for independent scanning probe applications” by Yoomin Ahn et al 2005 J. Micromech. Microeng. 15 1224-1229 doi:10.1088/0960-1317/15/6/012 the citation is used as reference and differs greatly from the instant invention. For walker applications an art recognized set of digital analog CMOS signal generating circuits comprising A/D and D/A signal circuits interface with the piezoelectric actuators and drive the bending modes described above from the walker device. Prior art flip chip bonding of chip stacks comprising signal generation and measurement as well as processing modules can be integrated with the walker actuators. Commercial flip chip services can be performed by Kulicke & Soffa flip chip division or a similar flip chip contractor company globally. Wafer and chip stacking references can also be found in the following references and at ZyCube inc (zycube.com)and Tezzaron Inc (tezzaron.com), two companies specializing in 3D chip assembly technology. See Tezzaron (Singapore) with their “Super Contact” technology. Wafer-Level 3-D Integration Moving Forward 3-D integration can alleviate interconnect delay problems, while reducing chip area. Three options are described, based on whether the ICs have been designed for 3-D interconnection. Philip Garrou, IEEE Fellow, President IEEE CPMT Society, Program Consultant, RTI International, Research Triangle Park, N.C.—Semiconductor International, Oct. 1, 2006. P. Garrou, “Future ICs Go Vertical” Semiconductor International, February 2005, Vol 28, No. 2. P. Garrou, “Is Wafer Interconnect Going 3D?” 56th Electronic Component Tech. Conf. (ECTC), 2006. R. Patti, “3D Design to Volume: A Look at Various 3D Applications, Their Designs, and Ultimate Silicon Results,” 3D Architectures for 3D Integration and Packaging, June 2005. M. Koyanagi, “A New Super Smart Stack Technology for 3D LSIs,” 3D Architectures for 3D Integration and Packaging, June 2005. A. Topol et al., “Enabling Technologies for Wafer Level Bonding of 3D MEMS and Integrated Circuit Structures,” Proc. Electronic Component Tech. Conf. (ECTC), 2004, p. 931. M. Umemoto, “High Performance Vertical Interconnection for High Density 3D Chip Stacking Package,” 54^{th} Electronic Component Tech. Conf., 2006, p. 616. C. Bower et al., “High Density Verticle Interconnects for 3D Integration of Silicon Integrated Circuits,” Proc. 56th Electronic Component Tech. Conf. (ECTC), 2006, p. 399. Z. Lemanos and J. Zolper, “Integrated Microsystems: The Next Technology Transition,” ManTech, 2004.</OL It is anticipated that there should be embodiments where the sample substrate is magnetically pulled into or pushed away from interaction with the scanner. In addition placement of magnetic or paramagnetic materials in or proximal to the scanner tip region 11 or the microsphere 10 will allow for magnetic actuation component forces to be exerted on the scanner and sample substrate. Electromagnetic coil structures can be used to generate attractive or repulsive forces between the scanner and substrate or between the cantilever and an external coil structure. Obviously the SPM probe of the gaming application and substrate can be coupled through standard piezo actuator or art recognized actuation means. In addition non-MEMS/NEMS substrates can be used in the invention as opposed to object 14 sample substrate. Sample substrate 14 can be patterned by micro or nano lithography for formation of surface features useful in gaming applications. An embodiment with one or more nanopores at the ball inertial contact or microsphere 10 will provide an alternate form for the scanner device which is useful for BioMEMS BioNEMS applications. In addition stacks of chips or wafer level arrays can be fabricated and operated in parallel. Spool type objects comprising materials such as nanotube, DNA/RNA/Proteins or hybrid nanobiological, nanoparticles, composites and nanomechanical objects and systems can be formed characterized and manipulated using spools to move, interact and store materials and information. One embodiment of special interest is the use of spooled nucleic acid molecules comprised of genes and chromosomes stored in spool form which are loaded into the actuator device and used for processes comprising fabrication, replication, analysis and editing/recombination of genetic material and systems. Spooled material such as data storage media can be stepped or translated through the device for reading, recording and editing. Combined data and molecular materials can be stored and manipulated on the same substrate spooled on the above described mechanisms and methods. LEAP extractor electrodes can be formed on the cantilever structures depicted in the figures above and below, preferably using FIB milling or electron beam lithography. Artificial Intelligence (AI) algorithms are preferably used to orchestrate motion and operational procedures of the above described device embodiments using computer device 47. Any art recognized AI programming methods or methods based upon existing AI algorithmic techniques can be used. Complex actions comprising characterization and fabrication methods can be evolved or designed using AI methods. Gaming processes such as board, screen, map, character, ect generation and modification can be performed by AI software in art recognized ways or novel means integrated with the instant invention. Combinatorial chemical synthesis, optimization and search protocols can projects can be performed using AI integrated embodiments. Sample substrate 14 can be patterned by any art recognized means but nanoprinting lithography and lift off lithography are particularly useful. Recently compact MEMS based electron and ion optics devices and systems have begun to be developed, integration of these type devices with the instant invention has multiple synergistic uses and is anticipated as a logical combination. Applications for the instant invention include lithographic mask repair and modification as well as using the probe tips of the invention as a caliper measuring and manipulation device. The compound cantilever depicted in FIG. 5 can be alternately not folded and form a bifurcated linear cantilever device with the microsphere contact point in the middle of the cantilever. Alternate embodiments where the computational, DSP and Digital/Analog and Analog/Digital conversion and communications circuits are contained on a substrate, stack or package self contained forming a device 50 are possible. In addition the orientation of the probe tips and inertial stepper/walker structures can be changed from those depicted to form alternate topologies. In particular insect derived geometries such as millipede and centipede as well as insect like orientations are envisioned. In addition spanning structures which couple multiple actuators of the device are envisioned as useful in some applications. These spanning structures can have structures comprising, nanopores, bearings or cantilevers through, attached, near or proximal to them. Various art recognized combinatorial array synthesis, replication, manipulation and screening methods can be synergistically integrated with the instant invention. In addition it will be noticed that genetic sequencing modes and methods can be carried out using the cantilever array and or spooling mechanism disclosed in the instant invention. Electromagnetic excitation of tip and objects such as sample materials on object 14, reagents, nanoparticles or nanomachines in IR, Visible, UV, Thz, or Microwave energy for detection or modification is to be carried out in certain embodiments. Replacement MEMS/NEMS tip arrays for in-situ replacement of probe apex regions is a useful process for the instant invention to prolong the use of the device and change functionality of the devices. It is known in the art of scanning probe microscopy that tip structures can and are damaged by use. The present invention proposes for replacement of tip regions for damage and physical, electronic, optical and chemical functionalization purposes. Various means for fabricating tip apex components from microelectonic, nanoparticle, nanotube and nanowire components will be obvious to those skilled in the art. The present invention can use oriented arrays of nanotubes synthesized in anodic alumina membranes, templated nanoparticles, microelectronic or nanofabrication derived cantilever tip modules or the like for modular tip fabrication. Adjustable spring constant mechanisms can be integrated with the above mechanisms and probes. Nanotube or molecular bearings can be attached to object 46 microsphere or spindle for tethering to substrate 14, object 50 MEMS/NEMS or other objects. Alternate embodiments use probe tips as alternate objects for microsphere or contact areas 10,40,41,42, 51,52,53,54,55 and or 56. In some further embodiments the tip structures fit into pores or divots in the sample substrate 14 and this limits wear of the tip apex and allows for calibrated incremental movement of the sample substrate, The sample substrate can be a nanopore array such as a nanofabricated substrate, self assembled substrate, anodic alumina or a derivative of such a material. Implementation of nanostepper movement by threading objects through nanopores in, on or proximal to the cantilever devices of the instant invention are anticipated as particularly useful application for the present invention. Lab on a chip, nanosystems and MEMS, NEMS, BioMEMS, BioNEMS, Nanofluidics, nanofluidics, modules with components comprised of designs using the instant invention technology are expected to provide numerous implementation possibilities. While the best mode for carrying out the invention has been described in detail, those familiar with the arts to which this invention relates will recognize various alternative designs and embodiment, variations and combinations for practicing the invention as defined by the previous claims and descriptions without departing from the conceptual scope of the invention.

What is claimed is:

1. A scanning probe means for use as a probe scanner and sample actuator to obtain means comprising high spatial resolution images, manipulations, actuation, fabrication, reactions, measurements, data recording and reading at high-temporal and spatial resolution, the probe comprising: at least one cantilever; at least one probe tip; at least one actuator means for generating motion of said compound cantilever; at least one measurement means for measuring tip probe interaction with samples and or between one or more tip probes; at least one signal generation and processing means for control of said scanner, actuator, measurement means and probe; at least one sample substrate, material, surface or object; a cantilever comprising a compound lever is formed from at least one beam which can be used to both scan at least one of the said probe tips and be used as an actuator for moving the sample substrate, sample object and or scanner in a linear or inertial stick slip fashion.

2. Device as in claim 1 with at least 1 torsion member used anchor at least 1 of said cantilevers where said cantilever has at least one probe tip, one actuator and one contact used to actuate said sample substrate, sample object or scanner.

3. Device as in claim 1 where said device is used to form a data recording and or reading device.

4. Device as in claim 1 where said sample substrate is operated in an electron microscope or focused ion beam milling machine.

5. Device as in claim 1 where said cantilever device or substrate has one or more synthetic nanopore integrated with its operation or structure.

6. Device as in claim 1 where said compound cantilever or sample substrate device has one or more adjustable nanopore on, through it or proximal to it.

7. Device as in claim 1 where said compound cantilever and or sample substrate device is used to perform Nanolithography.

8. Where said compound cantilever or sample substrate device in claim 1 has one or more mass spectroscopy channels operated in conjunction with it for measuring quantities, sample material quantities, compositions, manipulating, separating and assembling materials.

9. Device as in claim 1 where said compound cantilever or sample substrate device has one or more Scanning Atom Probe or LEAP microscope extractor electrode operated in conjunction with it.

10. Device as in claim 1 where said compound cantilever or sample substrate device has one or more microfluidic channels operated in conjunction with it for measuring sample material quantities, compositions, manipulating, separating and assembling materials.

11. Device as in claim 1 which has at least 1 power supply located on, in or proximal to the scanner device or sample substrate comprising one or more means such as a battery, fuel cell, electromagnetic energy conversion device or fuel container or engine.

12. Device as in claim 1 where said cantilever or substrate has one or more tip structure composed of a super hard material such as diamond, ceramic, osmium or the like.

13. Device as in claim 1 where said cantilever or substrate has a Landau level spectroscopy capability means effected through one or more tips, dual tip pairs or nanopore structures.

14. Device as in claim 1 where said device is used as a nanolathe.

15. Device as in claim 1 where said device is used to perform Raman spectroscopy.

16. Device as in claim 1 where said device is used as a linear and or rotational motor or actuator.

17. A MEMS or NEMS scanner, manipulator based motor comprising: at least one cantilever; at least one probe tip; at least 1 linearly and or radially movable object; at least one actuator means for driving interaction between probe and movable object; at least one measurement means for measuring probe interaction with said linearly and of radially movable object and or between one or more tip probes; at least one signal generation and processing means for control of said scanner, actuator, measurement means and probe; at least one object or means which interacts with the linearly and or radially movable object.

18. Device as in claim 16 where said radially movable object has at least 1 radially revolving bearing structure such as a nanotube bearing.

19. A Scanning Probe Microscope nanomanipulator used as a means for processes comprising game playing, screen saver graphic, nanomanipulation, erector set, chemistry kit and nanolithography comprising: at least 1 probe tip; at least 1 substrate; at least 1 actuator; at least 1 probe or pore measurement means; at least 1 computer controller for signal processing and algorithm interface with user or users; at least 1 user interface device; at least 1 data storage means for storing user interface dynamics data and or algorithms comprising game rules, construction components and or game state data; Said Scanning Probe Microscope nanomanipulator is used as a nanoscale means for users to interface entertainment and education processes orchestrated by said interface dynamics algorithms and hardware.

20. Device as in claim 19 where said means are attached to a communication means for interacting with at least 1 other user where interface and communications allows for game playing, nanomanipulation, erector set, chemistry education and nanolithography data to be shared between user interfaces and scanner/manipulator devices.

21. Device as in claim 19 where said means are integrated with or plugged into a mobile networking device comprising cell phone, PDA, digital cameras, TV remote controller, joystick, Gaming I/O device, mobile gaming system, laptop or similar computing capable device.

22. Device as in claim 19 where said means are integrated with a mobile networking device comprising cell phone, PDA, laptop, camera or similar computing capable device where said nanomanipulator SPM gaming mechanism is integrated with a user memory storage device such as a SIM card or data storage device comprising, a camera memory card, Flash card, RAM, EPROM, EEPROM, molecular electronics memory, transistor based data storage, disk drive, SPM probe based memory, disk drive or microdrive disk.

23. Device as in claim 17 where said means are integrated with a means for RF-ID capable functions.

24. Device as in claim 17 where said means are integrated with a combinatorial chemical or nanostructure array.

25. Device as in claim 17 where said means for input, output and processing of biological material is provided, said biological material is analyzed or manipulated by said device.

26. Device as in claim 17 where said means for input, output and processing of data from an in vivo implantable measurement and or manipulation device such as a RF enabled microchip or nanoscale device is provided, said biological material is analyzed and or manipulated by said devices.

27. Device as in claim 17 where said means for input, output and processing of data from an in vivo implantable measurement and manipulation device such as a RF enabled microchip or nanoscale device is provided, said biological material is analyzed or manipulated by said devices, a set of material sample materials is collected at time point 1 and is stored in one device and compared to sample materials at one or more subsequent times for biological analysis or manipulation processes.

28. Process where said device in claim 17 is operated using DNA, RNA, Proteomic or biochemical molecular sample objects and data.

29. Device as in claim 1 where said device or substrate has one or more waveguide structure.

30. Device as in claim 1 where said device is interfaced with a haptic force user interface.

31. Device as in claim 1 where said device sample substrate has both one or more gaming area and one or more combinatorial object synthesis, assembly or manipulation area.

32. Device as in claim 1 where said device is used as a nanotweezer nanomanipulator where said tweezers are chemically functionalized with material comprising nanotubes, nanoparticles, nano composites, nucleosides, nucleotides, polymers or nanomachines.

33. Device as in claim 1 where said device has one or more tunneling sensor used to measure displacement or characterize of one or more scanner probes or objects in or associated with said device.

34. Device as in claim 1 where said device has one or more coherent electron tunneling device integrated with it physically and or operationally.

35. Device as in claim 17 where said device has one or more tunneling sensor used to measure displacement of one or more scanner probe or objects in or associated with said device means.
